(19) United States
(12) Patent Application Publication
(10) Pub. No.: US 2025/0317679 A1
(43) Pub. Date: Oct. 9, 2025

(54) MICROPHONE APPARATUS

(71) Applicant: Audio-Technica Corporation, Tokyo (JP)

(72) Inventor: Takashi MURATA, Tokyo (JP)

(21) Appl. No.: 19/093,976

(22) Filed: Mar. 28, 2025

(30) Foreign Application Priority Data
Apr. 9, 2024 (JP) 2024-062705

(51) Int. Cl. H04R 1/08

(52) U.S. Cl. CPC H04R 1/086

(57) ABSTRACT

A microphone apparatus includes: a headband unit to be worn on a head of a user; and a microphone section having: a microphone support member extending from the headband unit; and a microphone unit provided on the microphone support member, in which the microphone unit has: an electroacoustic transducer, a housing having an internal space that houses the electroacoustic transducer, and having formed therethrough an opening that establishes communication between the internal space and an outside; and a breathable sheet member arranged to cover the opening.

### CROSS-REFERENCE TO RELATED APPLICATIONS

The present application claims priority to Japanese Patent Application No. 2024-62705, filed on Apr. 9, 2024, contents of which are incorporated herein by reference in their entirety.

### BACKGROUND OF THE INVENTION

The present disclosure relates to a microphone apparatus. There have been conventionally-known headset-type acoustic devices having a headband to be worn on the head of a user, and a sound collecting microphone (e.g. see Japanese Patent Application Publication No. H11-331970). Acoustic devices of this type include ones having a pair of speaker units, and ones not having speaker units, but having only a microphone function simply.

An acoustic device like the ones mentioned above is used by being worn on the head of a user, and there is a problem that, for example, in a case where the user uses the apparatus in a rainy situation or in a case where the user wears the apparatus at a concert or the like, a liquid such as rainwater or sweat penetrates into the microphone unit, and the apparatus malfunctions.

### BRIEF SUMMARY OF THE INVENTION

Therefore, the present disclosure has been made in view of the problem described above, and an object thereof is to provide a microphone apparatus that is unlikely to experience a malfunction of a microphone unit caused by the penetration of a liquid such as rainwater or sweat.

A microphone apparatus according to the present disclosure includes: a headband unit to be worn on a head of a user; and a microphone section having: a microphone support member extending from the headband unit; and a microphone unit provided on the microphone support member, in which the microphone unit has: an electroacoustic transducer; a housing forming an internal space that houses the electroacoustic transducer, and having an opening that establishes communication between the internal space and an outside; and a breathable sheet member arranged to cover the opening.

### BRIEF DESCRIPTION OF THE DRAWINGS

FIG. 1 is a perspective view of a microphone apparatus.

FIG. 2A is a figure depicting the microphone apparatus.

FIG. 2B is a figure depicting the microphone apparatus.

FIG. 3 is a side view of the microphone apparatus.

FIG. 4 is an enlarged view of a microphone unit.

FIG. 5 is an exploded perspective view depicting the configuration of the microphone unit.

FIG. 6 is a cross-sectional view of the microphone unit.

FIG. 7 is a schematic diagram for explaining a fall-off preventing structure of a wind screen.

FIG. 8 is a figure schematically depicting a configuration in which a recessed area is not formed.

FIG. 9 is a schematic diagram depicting a state where a sheet member is warped.

FIG. 10 is a figure depicting another configuration example of the microphone apparatus.

### DETAILED DESCRIPTION OF THE INVENTION

Hereinafter, the present disclosure will be described through exemplary embodiments, but the following exemplary embodiments do not limit the disclosure according to the claims, and not all combinations of features described in the exemplary embodiments are necessarily essential to the disclosure.

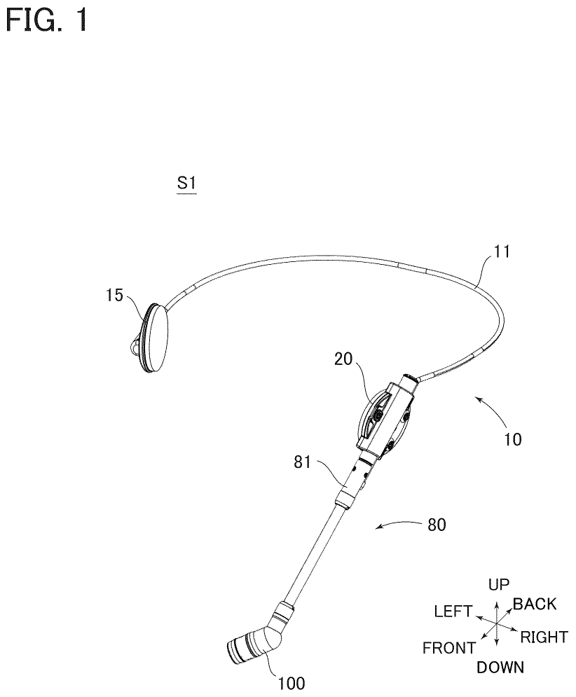

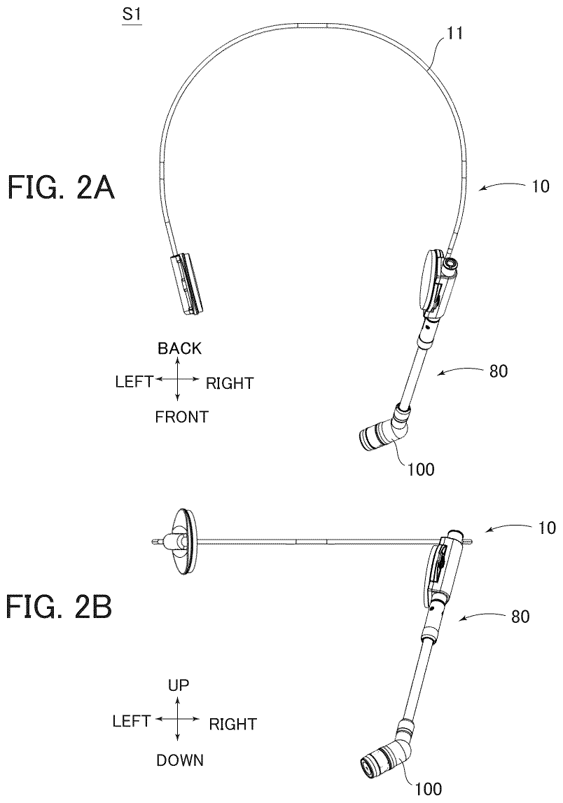

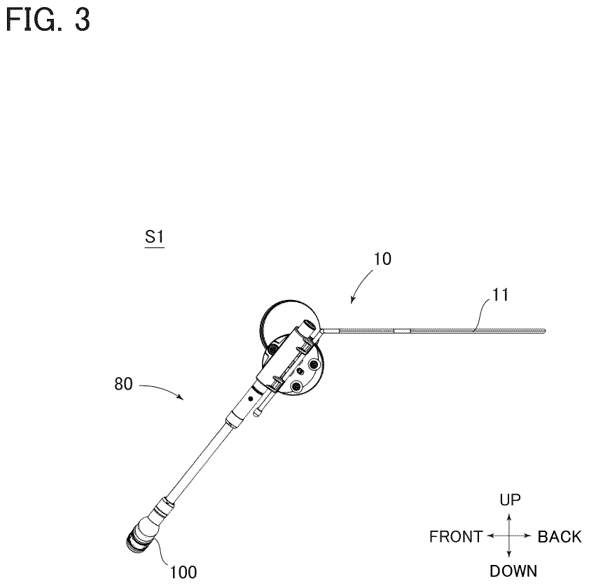

FIG. 1 is a perspective view of a microphone apparatus. FIG. 2A and FIG. 2B are figures depicting the microphone apparatus. FIG. 2A is a plan view, and FIG. 2B is a front view. FIG. 3 is a side view of the microphone apparatus.

As depicted in FIG. 1, a microphone apparatus S1 includes a headband unit 10 and a microphone section 80.

The headband unit 10 is a portion to be worn on the head of a user. The headband unit 10 has a head wire 11, a right contact pad section 15, and a left contact pad section 20.

The head wire 11 is an elastic wire formed in an approximately arc-like shape. In the microphone apparatus S1 of the present embodiment, the head wire 11 is provided in such an orientation that the head wire 11 extends from a side of the head of the user along the back of the head in a state where the microphone apparatus S1 is being worn on the head of the user. Note that the configuration of the present disclosure is not limited to such a configuration, but may be a configuration in which the head wire 11 is arranged in such an orientation that the head wire 11 extends from a side of the head to the top of the head.

The right contact pad section 15 is provided at one end of the head wire 11. The right contact pad section 15 has a flat shape. The right contact pad section 15 is a portion that abuts on the right side of the head of the head of the user.

The left contact pad section 20 is provided at the other end of the head wire 11. Similarly to the right contact pad section 15, the left contact pad section 20 also has a flat shape. The left contact pad section 20 is a portion that abuts on the left side of the head of the head of the user. The left contact pad section 20 supports the microphone section 80.

As depicted in FIG. 1, the microphone section 80 has a microphone support member 81 and a microphone unit 100. Whereas the microphone section 80 is supported by the left contact pad section 20 in the present embodiment, the microphone section 80 may be supported by the right contact pad section 15.

The microphone support member 81 is formed to extend from the headband unit 10. The microphone support member 81 has a round rod shape, as an example. The microphone support member 81 has a portion formed using a flexible member which can be deformed such that the orientation of the microphone can be changed. Specifically, the microphone support member 81 is supported by the left contact pad section 20 in such an orientation that the microphone support member 81 extends from the headband unit 10 toward the mouth of the user in a state where the microphone apparatus SI is being worn by the user.

The microphone unit 100 is provided to the microphone support member 81. The microphone unit 100 may be provided at any position of the microphone support member 81, and, in this example, is provided at an end of the microphone support member 81.

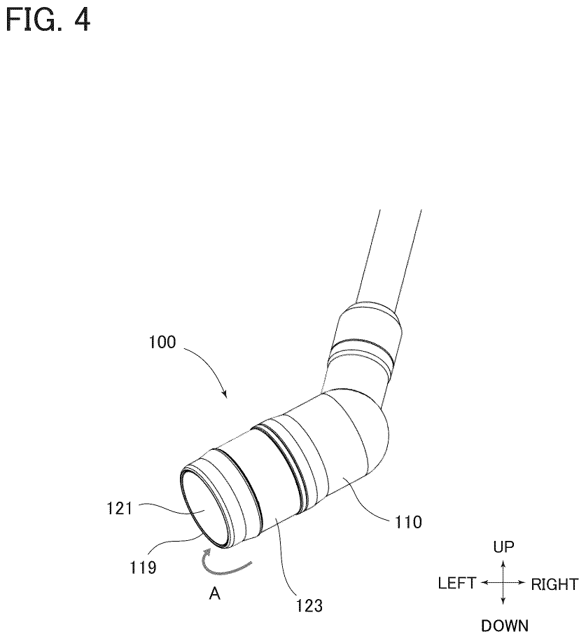

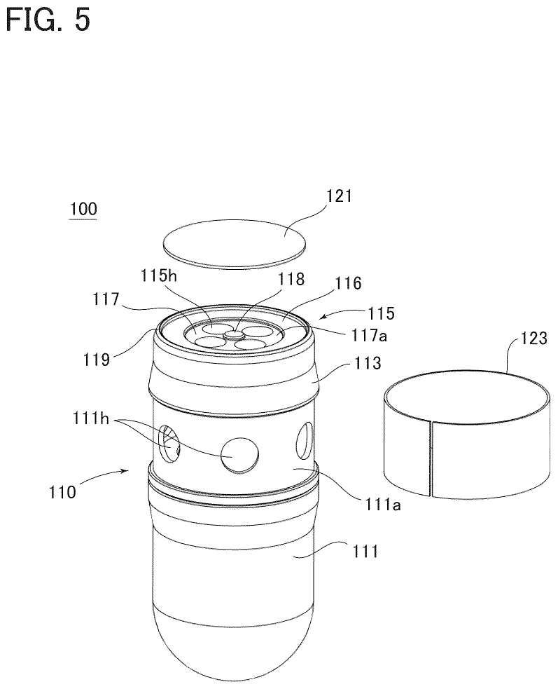

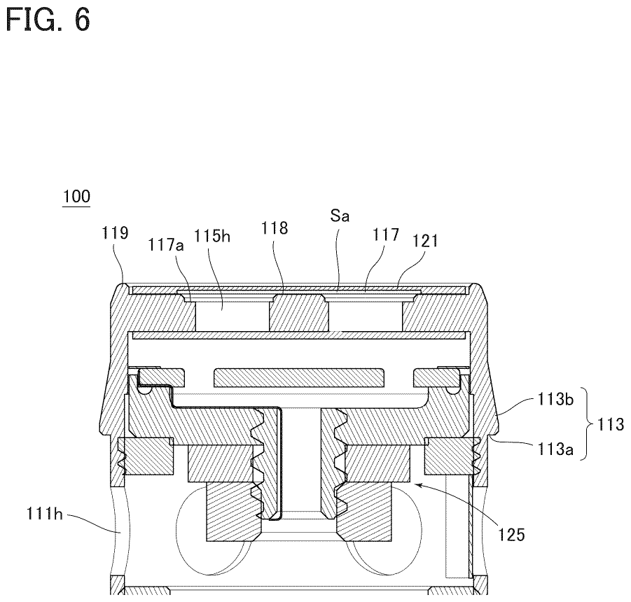

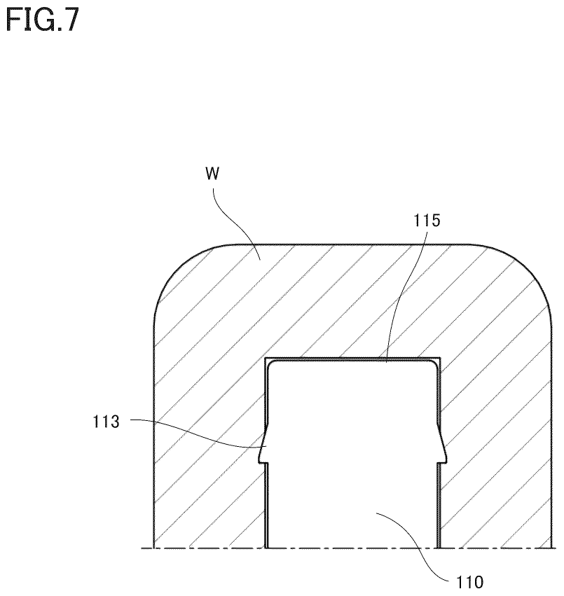

FIG. 4 is an enlarged view of the microphone unit. FIG. 5 is an exploded perspective view depicting the configuration of the microphone unit. FIG. 6 is a cross-sectional view of the microphone unit 100. FIG. 7 is a schematic diagram for explaining a fall-off preventing structure of a wind screen. Note that an illustration of a protection tape 123 (FIG. 4) is omitted in FIG. 6.

As major constituent elements, as depicted in FIG. 4 to FIG. 6, the microphone unit 100 has a housing 110, a sheet member 121, and an electroacoustic transducer 125.

The electroacoustic transducer 125 is an element that converts sound waves into electric signals, and a conventionally-known configuration can be used. As an example, the electroacoustic transducer 125 is an electret-capacitor-type microphone unit.

The housing 110 is a member that forms an internal space to house the electroacoustic transducer 125. The housing 110 has a tubular shape. Specifically, the housing 110 has a cylindrical shape. As depicted in FIG. 5, the housing 110 includes a peripheral wall 111 and an end 115.

The peripheral wall 111 is a portion forming the side surface of the housing 110. A plurality of holes 111h are formed through the peripheral wall 111. The holes 111h are sound holes for taking in sound from the side surface of the housing 110. In the present embodiment, specifically, the plurality of holes 111h are formed at an annular recess 111a formed on the outer circumferential surface of the housing 110.

The protection tape 123 is pasted onto the recess 111a to cover the plurality of holes. The protection tape 123 is a sheet-shaped protective member for preventing a liquid such as water or sweat from entering the inside of the housing 110. Although the shape of the protection tape 123 is not limited to a particular shape, as an example, the protection tape 123 has a thin quadrangular shape. For example, the protection tape 123 is pasted onto the recess 111a by a double-sided tape. As an example, the double-sided tape has holes formed at portions corresponding to the holes 111h. The protection tape 123 is a breathable material so as to prevent obstruction of sound collection by the electroacoustic transducer 125. In the present embodiment, the protection tape 123 is made of a material which is the same as the sheet member 121, as an example. Details of the material are mentioned later along with explanation of the material of the sheet member 121. Note that, in a case where the protection tape 123 is made of an expandable/contractible material, for example, a cylindrically-formed protection tape may be attached to the housing 110.

A protrusion 113 is formed on the peripheral wall 111. The protrusion 113 is a portion for preventing a wind screen W (FIG. 7) attached to the housing 110 from falling off. As depicted in FIG. 6, in this example, the protrusion 113 is formed at a position adjacent to the recess 111a. As an example, the protrusion 113 is formed in an annular shape. The protrusion 113 has a cross-sectional shape protruding radially outward from the housing 110. The diameter of the protrusion 113 is longer than the diameter of the other portions (including also the portion of the protection tape 123) of the housing 110.

Specifically, as depicted in FIG. 6, the protrusion 113 has a radial surface 113a and an inclined surface 113b. The radial surface 113a is a surface extending in a direction orthogonal to the direction in which the wind screen W is inserted. The inclined surface 113b is a tapered surface tapering toward the end 115 of the housing 110. In a state where the wind screen W (FIG. 7) is attached to the housing 110, the protrusion 113 contacts the wind screen W, thereby preventing the wind screen W from falling off.

FIG. 5 is referred to again. A fixation surface 116, a recessed area 117, a protrusion 118, and an annular rib 119 are formed at the end 115 of the housing 110.

The fixation surface 116 is an annular area. As an example, the fixation surface 116 is formed in a planar shape. The fixation surface 116 is a portion where the sheet member 121 mentioned later is pasted.

The recessed area 117 is formed on the inner side of the fixation surface 116. The recessed area 117 is formed to be concave from the fixation surface 116. Whereas the recessed area 117 is a circular area in this example, for example, the recessed area 117 may have a quadrangular shape, a polygonal shape, or an oval shape or a shape of a combination of these. Specifically, as can be understood from FIG. 6, the recessed area 117 is concave in a direction away from the sheet member 121 (the thickness direction of the sheet member).

Openings 115h are formed as sound holes in the recessed area 117. The openings 115h are sound holes establishing communication between the internal space and outside of the housing 110. The number of the openings 115h can be any number, and, in the present embodiment, four openings 115h are formed.

The sheet member 121 is arranged to cover the openings 115h. Similarly to the protection tape 123, the sheet member 121 is a member for preventing a liquid such as water or sweat from entering the inside of the housing 110. The shape of the sheet member 121 is not limited to a particular shape, and, in this example, the sheet member 121 is formed in a circular shape. For example, the outer circumferential section of the sheet member 121 is fixed to the fixation surface 116 by a double-sided tape.

Similarly to the protection tape 123, the sheet member 121 is a breathable material so as to prevent obstruction of sound collection by the electroacoustic transducer 125. In this example, the sheet member 121 is made of a material that is flexible, and can deform by receiving sound pressure. The sheet member 121 may be made of a woven fabric or a non-woven fabric (e.g. a porous material), and is made of a woven fabric as an example in the present embodiment. Specifically, for example, the sheet member 121 is made of a mesh fabric of a polymer material such as nylon or polyester.

In this example, the sheet member 121 has water repellency. As an example of the water repellency, it is sufficient if the result of a test performed on the basis of “JIS L 1092 Testing methods for water resistance of textiles, Water repellency test (Spray test)” satisfies the standards of Grade 1 or higher, and preferably the result satisfies the standards of Grade 2 or higher (Grade 1 and Grade 2 of JIS L 1092 are equivalent to Grade 1 and Grade 2 of the ISO 4920 tests, respectively).

The sheet member 121 may be water-penetration resistant or may not be water-penetration resistant. As an example of the water penetration resistance, it is sufficient if the result of a test performed on the basis of “JIS L 1092 Testing methods for water resistance of textiles, Test for water penetration (hydrostatic pressure method), Method A (low hydraulic pressure method) is equal to or greater than 100 mm.

The protrusion 118 is a portion protruding from a bottom surface 117a of the recessed area 117 toward the side of the sheet member 121. In this example, the protrusion 118 is formed at the middle of the recessed area 117. As depicted in FIG. 6, the protrusion 118 is formed such that the distance between the protrusion 118 and the sheet member 121 is shorter than the distance between the bottom surface 117a of the recessed area 117 and the sheet member 121. In the assembled state depicted in FIG. 6, the leading end of the protrusion 118 is not in contact with the sheet member 121.

### Technical Significance of Recessed Area 117 and Protrusion 118

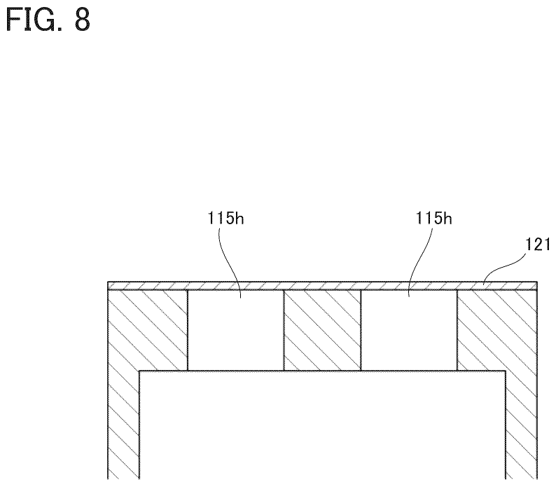

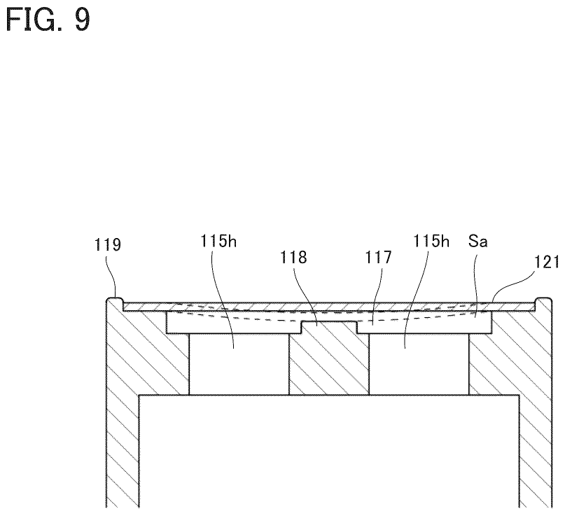

FIG. 8 is a figure schematically depicting a configuration in which a recessed area is not formed. FIG. 9 is a schematic diagram depicting a state where a sheet member is warped. As depicted in FIG. 8, in the microphone apparatus SI of the present disclosure, an end of the housing may be formed in a planar shape, and the sheet member 121 may be provided to cover its opening. Due to the sheet member 121 provided in this manner, the entrance of a liquid such as sweat into the inside of the housing through the openings 115h can be prevented as compared with a configuration not provided with the sheet member 121.

Although the penetration of a liquid can be prevented in the configuration in FIG. 8 also, in the present embodiment, the recessed area 117 is formed as mentioned before, and a space Sa (FIG. 9) is formed on the inner side of the sheet member 121. At a portion facing the space Sa, the sheet member 121 is not in contact with members of the housing.

According to such a configuration, the following advantages can be attained as compared with the configuration in which the sheet member 121 contacts members around the openings 115h as in FIG. 8. That is, even if a liquid permeates the sheet member 121, it is unlikely for the liquid to enter the openings 115h, and the penetration of a liquid can be prevented effectively. Moreover, in the configuration of the present embodiment, the sheet member 121 is flexible, and the recessed area 117 is formed. Accordingly, as depicted in FIG. 9, the sheet member 121 can be warped by receiving sound pressure. Accordingly, the air pressure (sound pressure) transferred to the electroacoustic transducer 125 (FIG. 6) is reduced, and the occurrence of so-called pop noise can be suppressed.

In a case where, for example, a user presses the sheet member 121 of the microphone apparatus SI with her/his finger undesirably, and a large external force is applied to the sheet member 121, it is expected also that the sheet member 121 is warped and deformed or is damaged. In view of this, the protrusion 118 is formed in order to prevent such deformation. The protrusion 118 abuts on part of the deformed sheet member 121 as in FIG. 9, and prevents deformation.

As an example, it is sufficient if the protrusion amount of the protrusion 118 is set to such a protrusion amount that the sheet member 121 having received an external force, and having been warped can return to its original shape (i.e. permanent deformation of the sheet member 121 does not occur). The shape of the protrusion is not necessarily limited to a columnar shape, but may be any shape. A plurality of protrusions may be provided.

### Technical Significance of Annular Rib 119

In the microphone apparatus S1 of the present embodiment, the annular rib 119 (FIG. 5, FIG. 6) is formed to surround the sheet member 121. The annular rib 119 is formed to protrude from the surface of the sheet member 121 in the thickness direction of the sheet member 121. According to such a configuration, the advantage that the sheet member 121 is unlikely to peel as compared with a configuration in which an annular rib is not formed as in FIG. 8 is attained. In addition, in the microphone apparatus S1 of the present embodiment, as depicted in FIG. 1 and FIG. 4, the side of the openings 115h (the side of the sheet member 121) is provided to be positioned below the base-end side of the housing 110 in a state where the microphone apparatus S1 is being worn by a user. Since the annular rib 119 is provided to the housing 110 in such a configuration, for example, even if a liquid such as sweat flows down along the microphone support member 81 and the housing 110, the liquid does not flow in the direction represented by an arrow A in FIG. 4, and is unlikely to reach the side of the sheet member 121. Accordingly, the advantage that a liquid is unlikely to penetrate into the housing 110 is attained.

### Advantages of Microphone Apparatus S1

As explained above, according to the microphone apparatus S1 of the present embodiment, the sheet member 121 is provided to cover the openings 115h of the housing 110 of the microphone unit 100. Accordingly, a liquid such as rainwater or sweat is unlikely to penetrate into the openings 115h as compared with a configuration not having the sheet member 121. Therefore, it is possible to provide the microphone apparatus S1 that is unlikely to experience a malfunction of the microphone unit 100 due to the penetration of a liquid such as rainwater or sweat.

In the present embodiment, also, the recessed area 117 is provided to the housing 110. Accordingly, the sheet member 121 can be warped as depicted in FIG. 9 when the sheet member 121 receives sound pressure; as a result, the sound pressure is reduced, and the occurrence of pop noise is reduced.

In the present embodiment, also, in the configuration provided with the recessed area 117 in this manner, the protrusion 118 is formed in the recessed area 117. Since the protrusion 118 prevents the sheet member 121 from being warped excessively, for example, even in a case the sheet member 121 is deformed by being pressed with a finger or for another reason, damage to the sheet member 121 is prevented.

### Modification Examples

Whereas the microphone apparatus SI not provided with speaker units is illustrated as an example in the embodiment mentioned above, the present disclosure can be applied also to a configuration in which the headband unit 10 has a pair of speaker units and a head wire. Here, the speaker units may be bone conduction units. Whereas the cylindrical housing 110 is illustrated as an example in the embodiment mentioned above, the cross-sectional shape of the housing may be any shape such as a polygonal shape, an oval shape, or a combination of these, other than a circular shape.

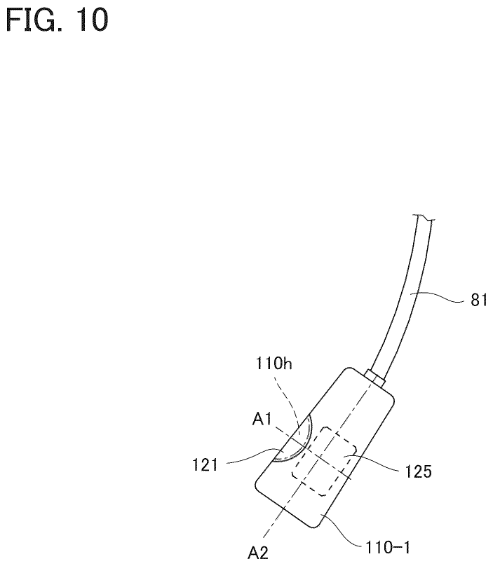

In the present disclosure, the orientation of the directivity axis of the microphone (electroacoustic transducer) relative to the housing 110 may be any orientation. FIG. 10 is a figure depicting another configuration example of the microphone apparatus.

As depicted in FIG. 10, for example, the electroacoustic transducer 125 may be arranged such that its directivity axis Al is in an orientation crossing the extending direction A2 of a housing 110-1. In such a configuration, as an example, openings may not be formed at the leading end of the housing 110-1, but an opening 110h is formed through the side surface of the housing 110-1. The shape of the housing 110-1 is not necessarily limited to a tubular shape, but it is sufficient if the shape is any shape that can house the electroacoustic transducer 125 therein. Whereas the opening 110h is a single hole provided at a position facing a sound collecting section of the electroacoustic transducer 125 as an example in this example, a plurality of openings may be formed. As an example, the extending direction A2 of the housing 110-1 is a direction parallel to the extending direction of the microphone support member 81.

The sheet member 121 is provided to cover the opening 110h. The sheet member 121 is made of a material similar to the material in the embodiment mentioned above, and, due to the sheet member 121 provided in this manner, a liquid such as sweat or rain is prevented from penetrating into the inside of the housing 110-1. Note that whereas holes equivalent to the holes 111h in FIG. 5 are not formed in this example, one or more holes having a similar function may be provided to the housing 110-1.

The sheet member 121 may be fixed in a curved surface shape matching the shape of the side surface of the housing 110-1, but this is not the sole example. The sheet member 121 may be fixed in a planar shape similarly to the embodiment mentioned above. Moreover, a structure like the recessed area 117 mentioned above may be formed; furthermore, a structure like the protrusion 118 may be formed therein.

Whereas the present disclosure has been explained using embodiments thus far, the technical scope of the present disclosure is not limited by the scope described in the embodiments described above, but various modifications and changes are possible within the scope of a gist of the present disclosure. For example, all or some of apparatuses can be configured functionally or physically distributed or integrated in any units. In addition, new embodiments that are generated by any combination of a plurality of embodiments are also included in embodiments of the present disclosure. Advantages of the new embodiments generated by the combination combine advantages of the original embodiments.

What is claimed is:

1. A microphone apparatus comprising:
a headband unit to be worn on a head of a user; and
a microphone section having: a microphone support member extending from the headband unit; and a microphone unit provided on the microphone support member, wherein
the microphone unit has:
an electroacoustic transducer;
a housing forming an internal space that houses the electroacoustic transducer, and having an opening that establishes communication between the internal space and an outside; and
a breathable sheet member arranged to cover the opening.

2. The microphone apparatus according to claim 1, wherein
the housing has:
a fixation surface to which an outer circumferential section of the sheet member is fixed; and
a recessed area that is provided to be concave from the fixation surface in a direction away from the sheet member, and has the opening formed therein, and
the sheet member is not in contact with a member of the housing in the recessed area.

3. The microphone apparatus according to claim 2, wherein
a protrusion protruding from a bottom surface of the recessed area toward the sheet member is formed at a middle of the recessed area, and
a distance between the protrusion and the sheet member is shorter than a distance between the bottom surface of the recessed area and the sheet member.

4. The microphone apparatus according to claim 1, wherein
the electroacoustic transducer is arranged such that a directivity axis thereof is oriented to cross an extending direction of the housing, and
the opening is formed through a side surface of the housing, and also the sheet member is provided to cover the opening.

5. The microphone apparatus according to claim 1, wherein
the housing has a tubular shape,
a plurality of holes for taking in sound from a side surface of the housing are formed through the side surface, and
a breathable protective member is provided to the housing so as to cover the plurality of holes.

6. The microphone apparatus according to claim 1, wherein
the housing has a tubular shape, and
a protrusion formed to protrude radially outward is provided to a side surface of the housing in order to prevent a wind screen attached to the housing from falling off.

7. The microphone apparatus according to claim 1, wherein
the housing has a tubular shape, and an end of the tubular shape is provided with the opening,
the microphone support member is fixed to the headband unit in such an orientation that the microphone support member extends toward a mouth of the user in a state where the microphone apparatus is being worn by the user, and
the housing is provided such that a side of the opening is positioned below a base-end side of the housing in a state where the microphone apparatus is being worn by the user.

8. The microphone apparatus according to claim 1, wherein
the housing has a tubular shape, and an end of the tubular shape is provided with the opening, and
the end of the housing is formed in an annular shape so as to surround the sheet member, and has formed thereon an annular rib protruding from a surface of the sheet member in a thickness direction of the sheet member.
